(19) United States
(12) Patent Application Publication
(10) Pub. No.: US 2008/0037718 A1
(43) Pub. Date: Feb. 14, 2008

(54) Methods and apparatus for delivering ancillary information to the user of a portable audio device

(76) Inventor: James D. Logan, Candia, NH (US)

Correspondence Address: CHARLES G. CALL, 215 W. HURON ST APT 2, CHICAGO, IL, 60610-3331, US

(21) Appl. No.: 11/821,899

(22) Filed: Jun. 25, 2007

Related U.S. Application Data
(60) Provisional application No. 60/817,564, filed on Jun. 28, 2006.

(51) Int. Cl. H04M 1/64

(52) U.S. Cl. 379/67.1

(57) ABSTRACT

A personal audio player including an audio program reproduction unit for delivering audio program content to a user and an announcement generator for delivering one or more timed announcement messages or alarm signals to the user of said audio player. A control interface accepts preference data specifying the time at which announcement messages are delivered to said user. The audio player may take the form hand-held music player or cellular phone which is coupled to an earpiece which may be touched to request an announcement message. Announcement messages may take the form of prerecorded human voices and may be transmitted to the player from a remote source. Announcement messages may also contain data from a remote source and may be delivered in both audible and visual form.

### CROSS REFERENCE TO RELATED APPLICATION

This application is a Non-Provisional of, and claims the benefit of the filing date of, U.S. Patent Application Ser. No. 60\817,564 filed Jun. 28, 2006 whose disclosure is incorporated herein by reference.

### FIELD OF THE INVENTION

This invention relates to electronic clocks and portable audio devices, such as cellular telephones and portable audio players and radios.

### BACKGROUND OF THE INVENTION

The wearing of wristwatches by young people is on the decline due to the ubiquity of digital time displays in cell phones, notebook computers, dashboards, and other electronic paraphernalia. But often these displays aren't readily available to the user at all times, particularly when away from home or the computer. As a result, young people commonly point to their wrists as a means of asking others if they know the time.

While devices that can “tell time,” such as a cell phone, are often carried by young people, they are often stored in an inconvenient location such as in a pocketbook and extracting the device just to see the time is often more trouble than it is worth.

Many users of portable music players and cell phones (“personal audio devices” or “PADs”), have a habit of traveling about with miniature speakers, or ear buds, in one or both ears. It is the purpose of this invention to allow such audio-based products to serve as a fully-useful time-telling device.

### SUMMARY OF THE INVENTION

The following summary provides a simplified introduction to some aspects of the invention as a prelude to the more detailed description that is presented later, but is not intended to define or delineate the scope of the invention.

A preferred embodiment of the present invention, here called the “Audio Timepiece,” may be implemented as a feature that may be readily added to the existing capabilities of electronic devices that produce audio output, such as the commonly used devices that connect to earphones or ear buds, including portable audio players like the iPod®, or cell phones that employ wired or wireless Bluetooth® connections to single-ear speakers.

The Audio Timepiece contemplated by the present invention would allow users of such devices to interact with the device in a way that would produce an audible audio announcement of the current time spoken through their ear buds or other speaker system. The audible announcement is preferably produced in a way that eliminate the need to manipulate and view a time display on the portable device in order to visually tell the time, or to ask a nearby wristwatch-wearer for the time.

The preferred embodiment of the invention preferably takes the form of a personal audio device comprising an audio program reproduction unit for delivering audio program content to a user, an audio announcement generator for delivering one or more timed announcement messages to the user, and a control interface for accepting preference data specifying the time at which the announcement messages are to be delivered to the user. The invention may be used to particular advantage in connection with an personal audio device such as a cell phone or a hand-held music player, for example an iPod® or the like, which supplies audio content to the user wearing an earpiece (earphone or earpod). Alternatively, the control interface may be located at some other position where it can be readily manipulated by the user.

The timing and content of the announcement messages are preferably programmed in advance by the user. A display device may display descriptive prompts or a menu to the user who then uses pushbuttons or touch sensitive controls to supply values for the preference data. An accessible control, such as a touch sensitive control on an earpiece, may be used to submit a command value that specifies that at least one of the announcement messages be played immediately to the user. Alternatively, or in addition, preference data may be accepted that specifies that at least one of the timed announcement messages be played at a specified time to provide a timed alarm or reminder.

The announcement message may indicate the time of day which is delivered to the user in audible form on demand, at pre-selected times, or at pre-selected intervals. The announcement message may preferably include a human voice recording that expresses a time of day in a spoken language. The preference data supplied by the user may also select one of plural different spoken languages in which announcement messages may be expressed, or may specify a selected one of several different human voice recordings. Timed announcement messages that are played at specified times may consist of an audible signal having a characteristic sound or having spoken content that indicates the time of day.

The announcement message may be supplied from a remote source. For example, a spoken reminder message may be transmitted to the audio device together with preference data that indicates when the transmitted message should be played. Alternatively, the message may contain information content, such as the news, traffic conditions, GPS location data, or the weather, that is then played at specific times (such as between music segments in a playlist of segments). These timed announcement messages may be presented to the user in either audible or visible form, or both.

As described in detail in the description that follows, the principles of the invention may also be used to provide other ancillary information to the user of a portable electronic device besides the time of day. These and other features and advantages of the invention will be better understood by considering the following detailed description.

### BRIEF DESCRIPTION OF THE DRAWINGS

In the detailed description which follows, frequent reference will be made to the attached drawings, in which:

FIG. 1 is a block diagram of an illustrative preferred embodiment of the invention implemented as a set of features added to a conventional Bluetooth® enabled cellular telephone; and

FIG. 2 is a plan view of a cellular phone which implements the invention.

### DETAILED DESCRIPTION

Forms of Audio Output

As personal audio devices (PADs) typically include, or can be readily modified to include, a electronic clock mechanism that can “tell time,” the time-of-day information often needed by a user resides in the unit. Several methods are available that can be used to convert this time data into an audio announcement for which can be delivered to the user of the Audio Timepiece. Such an announcement would ideally sound as close as possible to a person rendering the time in a selected spoken language (e.g., English), using phrases such as “five twenty four PM,” “half past two” or “quarter 'til five”.

One means to construct such an audio file would be to use text-to-speech synthesis software. Such software could convert such digital time information into spoken words on demand. Alternatively, actual human recordings of discreet numbers, and words such as “minutes”, “hours”, “half-past” and the other audio constructs of a time announcement could be used instead of speech synthesis. Such audio segments could be concatenated to form smooth sounding spoken renditions of the current.

The best audio rendition to deliver would be an actual recording of a human saying the entire phrase describing the current time. There are 1,440 minutes in a day and an announcement of each could be recited in approximately 3 seconds or less. Thus, storing an actual rendition of the full audio announcement for each minute of the day would require storage of about 1.2 hours or less of spoken word audio. Such audio would require less than 20 megabytes of storage using an ordinary compression algorithm for spoken word audio such as VoiceAge Corporation's ACELP®-related codec. Such a bank of stored phrases will soon be practical as music players and cell phones add ever-larger hard-drive storage to their devices. Alternatively, each hour from “1” to “12” could be a separately recorded word which is then concatenated with a spoken word or phrase for each of the sixty minutes of each hour. As a result, only 72 separate recordings spoken occupying less than 4 minutes of total recording time could be stored to create the needed audio announcement.

Additional Time-Related Features

The recording could be made available in different male and female voices or the recording of voices of famous people, and the user could select the voice that is found most pleasing. Different languages could also be selected, in part, as a way to help learn a second language. In addition, the way that time is expressed could be varied. For instance, 7:45 could be spoken as “seven forty-five” or as “quarter of eight” depending on user preference. The listener could also program the PAD such that the hour information was deleted. Thus, the device could simply say, “Ten of” and the user would know that the time was, for example, 2:50. The speed of the playback could also be user controlled. Such parameters could be configured in a set-up menu.

If desired, the user could select a feature that would introduce a certain amount of randomness into the time output such that the apparent time on many if not most occasions was stated to be ahead of the actual time, as described in my U.S. Pat. No. 6,411,568, “Timepiece for Automatically Displaying Times with Intermittent Fast Settings to Encourage Punctuality”.

This invention is most useful when the user is wearing ear buds or headphones but it may also be useful when the audio from the PAD that generates the time data is playing through speakers as well, for instance in the case where the phone, such as in a car, could use Bluetooth to turn a cell phone into a speaker phone.

Working in Concert with Other Sound Sources

The PAD containing the time data may also be generating audio (for instance, music in the case of an iPod or conversation in the case of a cell phone) when the user wishes to hear the time. This overlap of audio functions with the Audio Timepiece could be handled in one of two ways.

In the first way, the time-related audio would be presented in “talk-over” mode. That is, the user would hear both audio sources at the same time—as if two people were talking to the user at the same time. In the case where the user might be wearing ear buds or headphones, each sound source might come through one side or the other. In addition, the original source's volume might be lowered in order to focus the user's attention on the time-related audio. In the extreme, the original sound source could be turned off to give perfect clarity to the time-related audio.

Another variant of this first approach, when used in the context of a cell phone in use, is that the time-related audio could be heard by both parties to the call. Alternatively, the time announcement may be heard only by the user and not the other party. The cell phone user may select in advance whether the other party can hear or not hear the time announcement.

In a second method, the original audio source, if not coming from a broadcast or phone call, could be “paused” while the time information was announced. In other words, the podcast or music selection could be momentarily stopped while the time was read after which it would automatically resume. In a variation of this approach, the PAD might wait for a delay or space in the normal audio and insert the announcement into that space. Thus, if recorded audio was being played, the PAD might “look ahead” to see if there was a “quiet spot” coming up into which the time announcement could be inserted. If there was phone conversation taking place, the system might wait for both parties to stop talking for a moment and quickly insert the announcement then.

Interfacing with the Device

There are several suggested means by which a user could prompt the Audio Timepiece to announce the time on demand in response to a request signal accepted from the user.

One method offering a high level of control and convenience would involve using a dedicated button or other touch-sensitive means on the ear piece itself that when activated would cause the system to recite the time. Controls on an earpiece for adjusting the volume of a radio, selecting a station, and turning the device on and off are described in U.S. Pat. No. 4,539,708 issued to Elwood Norris on Sep. 3, 1985, the disclosure of which is incorporated herein by reference. Other devices for controlling the operation of are described in the following papers: (1) “Headphones with touch control” by Vincent Buil, Gerard Hollemans and Sander van de Wijdeven, ACM International Conference Proceeding Series; Vol. 111, Proceedings of the 7th international conference on Human computer interaction with mobile devices & services, pages: 377-378 (2005) ISBN:1-59593-089-2 and (2) “Multimodal ‘eyes-free’ interaction techniques for wearable devices” by Stephen Brewster, Joanna Lumsden, Marek Bell, Malcolm Hall and Stuart Tasker; Conference on Human Factors in Computing Systems; Proceedings of the SIGCHI conference on Human factors in computing systems; pages: 473-480 (2003) ISBN:1-58113-630-7. In addition, listening components such as the single-ear piece that works with a Treo® phone, offer buttons that include an up-volume, down-volume, and phone answer button. The Audio Timepiece could work by co-opting a specific use of a specific button to signal a need to hear the time. For instance, if the phone answer button was hit when there was no call coming in that could indicate a desire to hear the time instead. Or the down-volume could be pressed and held for a two second period, again, indicating a desire to hear the time.

Alternatively, there could be a button or touch-sensitive mechanism on the cord itself, if there is one, going from the central device (i.e. the body of an iPod) to the ear piece or pieces. Again, the button may or may not be dedicated to the time announcement function and if was multi-purpose, the time announcement would be instigated via a specific use of the button. Other mechanism for conveniently controlling the operation of the audio announcement mechanism are described in U.S. Pat. No. 6,596,955 issued to David Eves et al. on Jul. 22, 2003 and in U.S. Pat. No. 4,603,327 issued to Obie Leonard et al. on Jul. 29, 1986, which include sliders, buttons and zippers which form part a garment worn by the user and which may be manipulated to control electronic devices.

A button or touch-sensitive mechanism may also be placed on a wrist-band and coupled via a wireless connection, such as a Bluetooth® link, to the personal audio device. In this way, the user could simply tap the face of a wristwatch like device in an intuitive way to obtain an immediate audible announcement of the current time. This same wristband device may also provide an interface, which may include as an LCD display of menu options, as well as a continuous time display. Thus, the user is provided with a “wristwatch” that not only displays the time in the usual way, but also establishes the times at which alarms or pre-recorded messages are to be played to the user in audible form.

Finally, a time announcement could be signaled by manipulating a button or other similar device on the actual body or housing of the personal audio device (PAD). This method would be less convenient than manipulating a button removed from the main body of the device, but would still accomplish the task of communicating time information to the user without pulling the phone of its storage location. If discretion was advised (for instance, if the person were in a meeting and still had their phone ear piece on and didn't wish to appear to be watching the clock) or if the user's eyes needed to be somewhere else, receiving the audio in this manner would still be effective.

Another non-tactile means to command the system to recite the time would involve voice input. If the person was wearing an ear-piece that also had a microphone built-in (as is quite commonly the case with phone ear-pieces), this microphone could be used to command the system. To implement such a feature, the unit would need to be in perpetual stand-by mode, able to discern when the user spoke the relevant command. Such simple word recognition abilities are currently built into cell phones, however, a button needs to be pushed to activate them.

Finally, another means for controlling the recitation of time, that could supplement or replace the ones mentioned above, would involve programming the device to recite the time on a periodic basis. For instance, the system could say the time every ten minutes or every hour. This option eliminates the need for the user to activate the announcement, and would be particularly useful when the user of the device needs to be reminded of the time periodically. The user interface provided by the device may accept a preference value from the user specifying that audible announcements (spoken time announcements, tones, chimes, etc) which, at the user's option, are preferably produced every n minutes where n is selected from a group comprising 60, 30, 15, 10, 5 and 1. Thus, for example, the user can enter a preference value that specifies that a chime-like sound be produced every 15 minutes, or that the time be stated in a spoken voice announcement every half-hour. Moreover, the device may programmed to begin announcing the time at a programmed start time, thereby acting like an “alarm clock” to alert the user that specific time of day is nearing or has already occurred.

A variation of this idea would be for the device to use sounds instead of voice to indicate the time. Thus, if the user wished to be aware of the passing of every ten minute interval, the device could be programmed to make a specific tone every ten minutes much like a church bell rings every hour.

In addition, just like some clocks use chimes to indicate the top of the hour with the number of chimes indicating the specific hour, the Audio Timepiece could use similar logic to signal time intervals. Thus, three tones could indicate half-past the hour, if tones were being produced every ten minutes. Different sounding tones could be used for different parts of the hour or day adding some “audio color” to the presentation.

Alternatively, a nearest approximation of the exact time information could be automatically announced only during audio gaps in an uninterrupted or segmented program, such as between songs in a playlist or between broadcast segments. If a programmed time of announcement, such as 2:15, had occurred during the playing of a song, an automatic announcement saying “It is now after two-fifteen” could follow the song. If the duration of the next program segment is known, and if it will overlap a programmed announcement time, an automatic announcement such as (“It is almost two o'clock” or “It is 2 minutes before two o'clock”) could be produced before the next program segment is played.

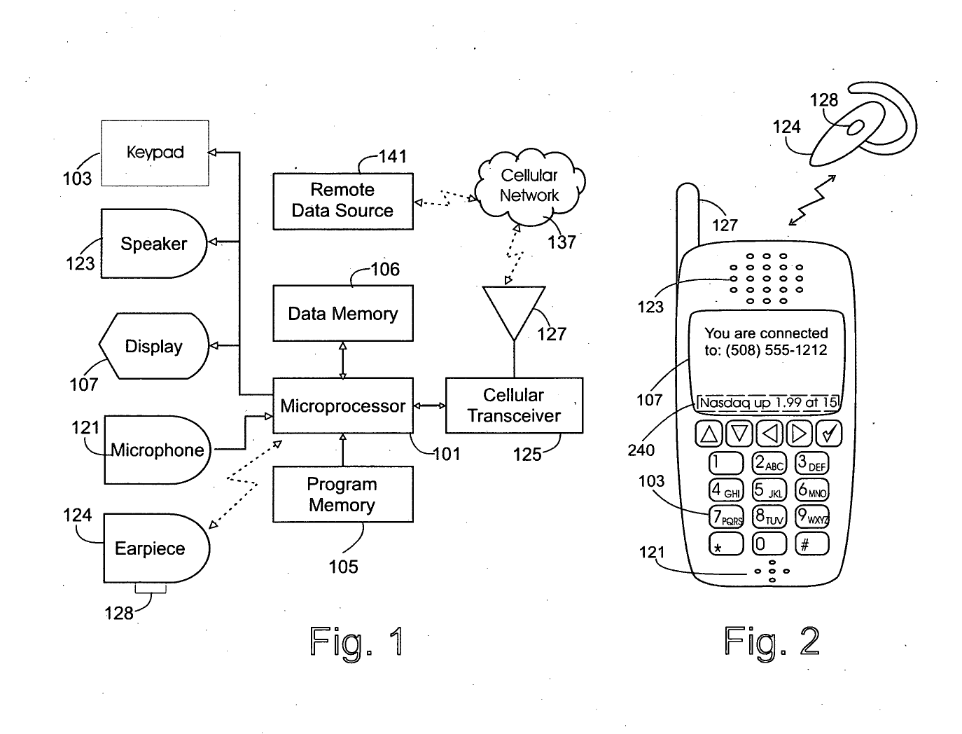

In general, the personal audio device that incorporates the mechanism for issuing time indications and timed messages and alarms may be programmed using an interface made available by the device for accepting preference data from the user. For devices such as cell phones and portable audio players that already include an interface, typically including an array of pushbuttons (seen at 103 in the cell phone embodiment seen in FIGS. 1 and 2) and a visible display for producing menus and prompts (seen at 107), the interface needed to accept command signals and stored preference values that establish the timing and the characteristics of audible announcements

Alarms and Messages

As noted above, the audio announcement system preferably permits users to program times when time announcements (i.e. “alarms”) should be produced. These alarms may take the form of spoken announcements (including spoken reminders recorded by the user), alarms sounds, or special “ring tones” that would ring in the ear piece. Thus, the user may use a microphone coupled to the personal audio device to record a reminder message and further use an interface provided by the device to specify the time when the reminder message is to be played.

Timed reminder messages may also be recorded at remote locations and transmitted to the personal audio device for playback at a time designated by the person recording the message. For example, the message “Don't forget to pick up a loaf of bread” might be transmitted to the personal audio device and playback may be specified for 5:00 pm, or at the earliest time after 5:00 pm when the personal audio device becomes operative. This provides a convenient way to transmit audio message to a user for playback at later times when the content of the message will be most useful and when the user's use of the personal audio device indicates that he or she is ready to receive such messages.

If the system was able to discern whether an ear piece or headphones were being used, it would use such audio output means or vibrators to announce the alarm or the receipt of an incoming message. If the ear piece or headphones weren't in use at the time of the alarm or message, then the device could emit an audible or tactile alarm similar to how a cell phone does today.

An added advantage of the alarm or message being played over ear pieces or headphones is that privacy would be preserved. In addition, because the alarm would be private, the user could have the option of recording a special message related to the alarm, such message being played back at the time of the alarm. Alternatively, the user could select pre-recorded messages to be played back during alarm times, including messages that may have been recorded by the user at a previous time.

Additional Data

In addition to the time-of-day, many personal audio devices also store other data that users might wish to receive in audio form while wearing earphones or other listening devices. For instance date information could be available on the PAD and could be accessed, for instance, by holding down the key that otherwise activates the time announcement. In the case of a GPS-based cell phone, the location could be made available in audible form, again, via a simple interaction with an interface element, or via a voice request such as “Where am I?” Alternatively, the PAD might indicate to the listener when he or she is at a pre-specified location by reciting an audio message or specific sound. If a user is willing to accept such information, advertisements could be sent to the user indicating when the user is located near to a particular vendor. GPS data could also be used to select and send to the user announcement messages that indicate up-to-the-minute traffic conditions on the route a user has selected. In the case of a music player, metadata about the music would be available including the name of the song being played, other songs in the library, and songs coming up in the playlist by simply toggling an interface element associated with the PAD or speaking the request into the microphone. Thus, the listener might speak into the microphone associated with the PAD Bluetooth earpiece a question such as. “What song is this?”

Some network enabled PADs would also be capable of receiving email. For these devices, the user could program the PAD to emit an audible announcement or sound whenever an email was received by the PAD. Such audio signals might only be produced if the PAD discerned that the earpiece was being worn if possible. As is the case, with other email devices, email announcements might be filtered such that only emails from certain parties produced an audio signal.

Such non-time data could be represented in audio form using the techniques described above, that using text-to-speech technology, recorded voices, etc. The user interface would need to be elaborated to allow for the selection of more than one data type, however. This could be done by adding additional buttons, or by allowing more means of activating a given button, such as using a “double tap” to access date information or using a “press and hold” to hear a menu of additional information. Voice recognition options could be extended to allow for the recognition of more commands, as well. The user would also have the option of programming the PAD such that some information would be announced in a pre-set manner. That is, the date could be set to be always announced when the time is requested.

Audio Crawl

The music player or cell phone device might have one or more means of connecting with information sources via a network connection. Such connections could include a cell phone or WiFi connection. With such a connection, the audio device could be programmed to download periodically audio files containing news, business information such as stock quotes, sport scores, weather, and similar information.

The headlines or highlights from such stories could then form the basis for an “audio crawl”—a running string of audio story headlines that a user could listen to when desired. The system would attempt to concatenate such segments in such a way that it sounded smooth by interleaving transitional phrases and the like.

The user could program the audio device to play back just certain types of stories—ones that had been classified in specific categories, given specific tags, had a certain level of importance, etc. The audio information could be selected, delivered and presented to the user of the portable audio device in the manner described in U.S. Pat. No. 5,732,216 issued on Mar. 24, 1998 entitled “Audio Message Exchange System;” U.S. Pat. No. 5,721,827 issued Feb. 24, 1998 entitled “System for Electrically Distributing Personalized Information;” and U.S. Pat. No. 6,199,076 issued on Mar. 6, 2001 entitled “Audio Program Player including a Dynamic Program Selection Controller,” the disclosures of which are incorporated herein by reference. As described in those patents, audio content is delivered to each user under program control, and the user may then “surf” through the content of that material using simple controls built into the audio playback device.

The user could also program the device to play the crawl at certain times such as between every tenth song or at the top of the hour, at the end of phone calls, etc.

As accessing the network to download audio could incur network charges, the frequency of updating could be controlled by the user. Such frequency could be set to vary by time of day, or day of the week, or for certain specific time periods. The user could also have the option to request long or shorter versions of particular stories, story types, or all stories.

The user could also interact with the stream in several ways: either through tactile input such as pressing a button (either on the earpiece or audio device) or through voice commands. Such commands could start or stop the audio crawl, or skip to the next item. In addition, a command would be available to “click” on a story. Once clicked upon, the detailed version of that story would then start to play. Interacting with another button could stop the story playback

Text Crawl

The system could also display the text version of the audio crawl on the display of the audio device itself. If the user were unable to wear headphones, or play the audio out loud, or just preferred the text version, then just seeing text on the display (with no accompanying audio) might be the preferred output mode. Such text could scroll across the screen or alternatively, larger blocks of text that didn't move could be displayed. Such blocks of text could then be replaced with new text upon command or in a pre-arranged timed manner.

Such a text display system could be particularly useful for keeping users up to date with their personalized information. In the case of a clamshell-type cell phone for instance, the phone could be programmed to display such timely information each time the cover was opened in place of the normal picture “screen saver” used now. As such, the Text Crawl could be offered with or without the accompanying audio files and playback capability.

The system could also track which segments of text had been presented, and how much time had transpired until another function on the device had been initiated. With such information, the system could make a guess as to whether the user had read the information or not. The user could then have the option of not having that information represented the next time text was displayed.

Such a system would differ markedly from current cell phone information-retrieval functions that require the user to wade through multiple levels of menus to “fetch” the information, usually by using their cell phone to gain Internet access whereupon a WAP web page can be read. The displayed text associated with a Text Crawl would be presented on the first screen a user saw upon accessing their phone or music player, replacing such current displays such as favorite photos and the like. Typical phone command options would still be visible on the screen, however, allowing for instant access to the phone's normal functions.

In one embodiment, the PAD is programmed to receive data on a periodic basis by automatically accessing the network. This periodic refresh could be accomplished either by the phone calling out, or by the network contacting the phone to download the data. While this information download would normally be done over the cell network including 3G networks, it could also be opportunistically done over a WiFi or WiMax network if the phone had such general web-surfing capability included in its WiFi or WiMax interface.

As in the case of audio file downloads, such polling of the network could result in network charges. As such, the user could control the frequency of downloads and amount of material downloaded. Downloads could be suspended for a period of time after the reading of text as a means to reduce network usage. An overall budget could also be established.

Alternatively, the network operator, to stimulate usage of the invention, could use excess network capacity to download data. That is, data would be downloaded only when there was adequate network capacity, resulting in the possibility of some “blackout periods” when fresh data would not be available. Under this scenario, the time of the last download could be available to the user so that the freshness of the information would be apparent.

### Illustrative Embodiment

FIGS. 1 and 2 of the drawings depict an illustrative implementation of the invention which provides a number of new features and functions to a conventional Bluetooth® enabled cellular phone.

As described below, the invention may be used to particular advantage in connection with a cellular telephone and may be implemented using conventional components of the type commonly used in advanced cellular phone systems. The makeup and organization of these components is illustrated in FIG. 1 of the drawings and consists of a microprocessor 101 that executes routines stored in a program memory 105 and manipulates data stored in a data memory 106. Routines may be initiated by the operator's manipulation of a keypad 103. Pressing a given key on the keypad 103 initiates a routine defined by a stored program in the program memory 105. The cellular phone further includes a display 107 that typically takes the form of a small, backlit LCD panel. U.S. Pat. No. 5,737,394 entitled “Portable telephone apparatus having a plurality of selectable functions activated by the use of dedicated and/or soft keys” describes the manner in which both the dedicated keys of a keypad and soft keys may be used in combination to implement a menu driven control arrangement for a cellular telephone.

The cellular telephone further includes a microphone 121 for capturing spoken voice signals from the operator, a built-in speaker 123 for delivering audible sounds to the operator, an wireless earpiece 124 which communicates with the cellular phone via a short-range Bluetooth radio link, and a cellular transceiver 125 for sending and receiving radio frequency transmissions to and from the cellular telephone system via the antenna 127. As noted above, the earpiece 124 may be equipped with suitable sensors or buttons (as indicated at 128) which may be used to initiate or control functions, such as generating an audio time playback. The cellular network seen at 137 provides a long range data pathway which may be used to connect to a remote data source seen at 141, which may be an Internet resource coupled to the cellular network 137 via a suitable gateway (not shown).

FIG. 2 shows the exterior of an illustrative cellular telephone handset which houses the components shown in the block diagram of FIG. 1. The handset uses a conventional numeric keypad 103 for dialing and softkeys whose function depends on the content shown on the display 107. The softkeys include cursor keys seen generally at 210 which may be used to navigate menu display options presented on the display screen 107. In this way, the user may be presented with menus which permit the selection of special functions, such as indicating the language and format of messages such as time of day indications that are preferred by the user.

The data memory 106 and the program memory 105 may be employed to store routines and data for generating audio information bearing signals which are delivered to the user on request (for example, when a button 128 is touched on the earpiece 124), to indicate the time of day, the user's current location (as determined by a built in GPS or other location sensor), or to present data from a remote data source 141. The data from a remote source may include the combination of a recorded message from a remote location and the specification of a time of day when the transmitted recorded message is to be played, or it may comprise the ancillary data produced as an audio or text “crawl” at times specified by the user or by timing data that accompanies the data from the remote source 141. As noted above, the audio information may be presented in a language selected by the user, or in a format selected by the user. For example, the user may indicate that time announcements are to be spoken in English in “talk-over” mode.

Alternatively, as discussed above, the microprocessor may be programmed to deliver this information at predetermined intervals or when conditions sensed by the microprocessor are satisfied. The audio message may be generated at the time predetermined programmed conditions are satisfied, such as when the user is at a particular location, as described in U.S. Pat. No. 6,631,271 issued on Oct. 7, 2003 entitled “Rules Based Methods and Apparatus for Generating Notification Messages based on the Proximity of Electronic Devices to One Another” and in U.S. Pat. No. 6,996,402 issued Feb. 7, 2006 also entitled “Rules Based Methods and Apparatus for Generating Notification Messages based on the Proximity of Electronic Devices to One Another,” the disclosures of which are incorporated herein by reference. The user may set up rules which define the conditions which are to be satisfied when an audio message is delivered using the keypad 103 and the navigation cursor keys to enter the rule definitions using a menu driven entry method as described above.

The display screen 107 may be employed to display prompts and menus which assist the user to provide preference data that controls the nature and timing of the timed audible announcements or text crawl messages presented to the user. The “text crawl” as illustrated at 240 in FIG. 2 which is displayed simultaneously with or instead of the “audio crawl” having the same content. As seen at 240, the text crawl and/or audio crawl may be activated to generate predetermined information when predetermined programmed conditions are satisfied as noted above.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. A personal audio player comprising, in combination:
an audio program reproduction unit for delivering audio program content to a user of said audio player,
an audio announcement generator for delivering one or more timed announcement messages to the user of said audio player, and
a control interface for accepting preference data specifying one or more conditions which, when satisfied, determine the time or times at which said announcement messages are delivered to said user.

2. A personal audio player as set forth in claim 1 wherein said personal audio player is coupled to an earpiece for delivering said audio program and said announcement messages to said user in audible form.

3. A personal audio player as set forth in claim 2 wherein said control interface includes a control input mounted on or near said earpiece for accepting preference data from said user specifying at least some of said one more conditions.

4. A personal audio player as set forth in claim 3 wherein said preference data includes a command value that specifies that at least one of said announcement messages be played immediately to said user.

5. A personal audio player as set forth in claim 1 wherein said preference data specifies that at least one of said timed announcement messages be played at a specified time.

6. A personal audio player as set forth in claim 5 wherein said at least one announcement message indicates the time of day.

7. A personal audio player as set forth in claim 6 wherein said at least one announcement message is a human voice recording that expresses a time of day in a spoken language.

8. A personal audio player as set forth in claim 7 wherein said preference data specifies a selected one of plural different spoken languages in which said at least one announcement message may be expressed.

9. A personal audio player as set forth in claim 7 wherein said preference data specifies a selected one of plural different human voice recordings used to record all or part of said at least one announcement.

10. A personal audio player as set forth in claim 5 wherein all or part of said at least one announcement message comprises a spoken human voice announcement.

11. A personal audio player as set forth in claim 10 wherein said spoken human voice announcement includes a recording of a human voice.

12. A personal audio player as set forth in claim 10 wherein said spoken human voice announcement consists at least in part of a synthetically produced human voice.

13. A personal audio player as set forth in claim 5 wherein said one of said timed announcement messages played at a specified time consists of an audible signal having a characteristic sound or having spoken content that indicates the meaning of the message.

14. A personal audio player as set forth in claim 1 wherein said audio announcement generator produces a sequence of timed announcements at times specified by said preference data.

15. A personal audio player as set forth in claim 14 wherein said times occur every n minutes where n is selected from a group comprising 60, 30, 15, 10, 5 and 1.

16. A personal audio player as set forth in claim 15 wherein at least some of said timed announcement messages consist of an audible signal having characteristics which indicate the time of day.

17. A personal audio player as set forth in claim 1 wherein at least one of said timed announcement messages is supplied to said personal audio player from a remote source via a communication link.

18. A personal audio player as set forth in claim 17 wherein said at least one of said timed announcement messages is presented to said user in either audible or visible form, or both.

19. A personal audio player as set forth in claim 1 wherein said control interface is located remotely from said audio player at a position where it is readily manipulated by said user.
